(19) United States
(12) Patent Application Publication
(10) Pub. No.: US 2017/0168082 A1
(43) Pub. Date: Jun. 15, 2017

(54) APPARATUS AND METHOD FOR MOTION VECTOR THRESHOLD DETERMINATION

(71) Applicant: Checkpoint Systems, Inc., Thorofare, NJ (US)

(72) Inventors: Donald Matthew Johnson, Charlotte, NC (US); Brian R. Dobeck, Monroe, NC (US)

(21) Appl. No.: 14/969,522

(22) Filed: Dec. 15, 2015

(51) Int. Cl. G01P 13/00; G06F 1/32

(52) U.S. Cl. CPC G01P 13/00; G06F 1/3206; G06F 1/3234

(57) ABSTRACT

An apparatus is provided including processing circuitry configured to determine a gravity vector of a device, detect a motion of the device, calculate a force vector of the motion, compare the force vector to the gravity vector to determine a vector difference, and determine if the vector difference satisfies a predetermined difference threshold.

### TECHNICAL FIELD

Example embodiments generally relate to motion detection and, in particular, relate to motion vector threshold determination.

### BACKGROUND

Security devices may be attached to products or packages in stores warehouses, shipping sites, or the like to inhibit theft and/or track movement of the products or packages to prevent or limit misplacement. The security devices may have a power supply, such as a battery, which is discharged at any time the security device is active. Thus, the useful life of the security device may be limited based on the rate of discharge.

In instances in which the security device transmits a beacon signal or location data for product or package location tracking, the location determining device or server, which receives the beacon or location data, may be limited in the number of devices which may be tracked, such as twenty devices. In some instances, the limitation of the number of devices which can be tracked simultaneously may be due to saturation of the radio frequency band. For example, 50, 100, 200, or more devices transmitting beacons at the same time may cause saturation. In some instances, the location determining device or server may have limited processing capability, such as for a predetermined number of security device locations, which may cause additional devices to not be tracked, or in some cases excessive beacons or location data may limit or prevent any security device from being tracked.

Typical security devices may attempt to resolve simultaneous transmission of beacons or location data and/or increase battery life by utilizing a trembler or vibration detector. The beacon or location data may be transmitted in instances when motion of the security device is detected and cease when motion is no longer detected. However, the vibration detector may not be capable of differentiating between a security device being in motion and a shelf or rack, where the product or package which the security device is attached resides, being disturbed, such as being bumped by a shopping cart, or surrounding packages being picked up. This lack of differentiation may cause the location tracking data to be obfuscated in instances in which a significant number of security devices are disturbed, but not actually in motion. The obfuscation of the location tracking data may increase risk of loss during the period in which the location tracking data is obfuscated. The battery life extension may also be frustrated due to the lack of motion detection, the security device may transition to the active state more often than is desirable and/or when unnecessary.

### BRIEF SUMMARY OF SOME EXAMPLES

Accordingly, some example embodiments may enable a motion vector threshold determination as described below. In one example embodiment, an apparatus is provided including processing circuitry configured for determining a gravity vector of a device, detecting a motion of the device, calculating a force vector of the motion, comparing the force vector to the gravity vector to determine a vector difference, and determining if the vector difference satisfies a predetermined difference threshold.

In another example embodiment, a method is provided including determining a gravity vector of a device, detecting a motion of the device, calculating a force vector of the motion, comparing the force vector to the gravity vector to determine a vector difference, and determining, using processing circuitry, if the vector difference satisfies a predetermined difference threshold.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a functional block diagram of a system that may be useful in connection with a motion vector threshold determination according to an example embodiment;

FIG. 2 illustrates a functional block diagram of an apparatus that may be useful in connection with motion vector threshold determination according to an example embodiment;

FIG. 3A illustrates a security device according to an example embodiment;

FIG. 3B illustrates a motion vector threshold determination loop in accordance with an example embodiment;

FIG. 3C illustrates a difference vector determination according to an example embodiment; and

FIG. 4 illustrates a method for motion vector threshold determination in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

In some examples, the example embodiment may provide an apparatus and method for detecting motion of a device, such as a security device, and comparing a calculated force vector for the motion to a determined resting gravity vector. The device may determine if a vector difference satisfies a predetermined difference threshold, e.g., a motion vector threshold.

Satisfaction of the predetermined difference threshold may cause the device to transition to an active state, in which a beacon signal or location data is transmitted to a location tracking device, in which electromagnetic field or radio frequency detection is commenced, in which verification of a security lanyard integrity is commenced, or the like. The device may additionally or alternatively be configured to detect the cessation of motion and transition to an inactive state in which transmission of the beacon signal or location data ceases, electromagnetic field or radio frequency detection is terminated, and/or verification of the security lanyard integrity is discontinued.

The transition between the active and inactive states may be performed based on the satisfaction of the vector motion threshold determination may significantly extend battery life of the device, since the device may only be active when the device has moved in a specified direction. For example, if the specified direction is defined to identify vertical motion, movement of the device in the horizontal plane based on disturbing the shelf or rack, or disturbing surrounding products or packages, without picking one up, such movement would not cause the device to transition to the active state. Since only the detection of vertical motion of the device transitions the device to an active state, the location tracking device may only receive the beacon signal or other location data form devices moving in the specified direction, preventing or limiting saturation of the location tracking device.

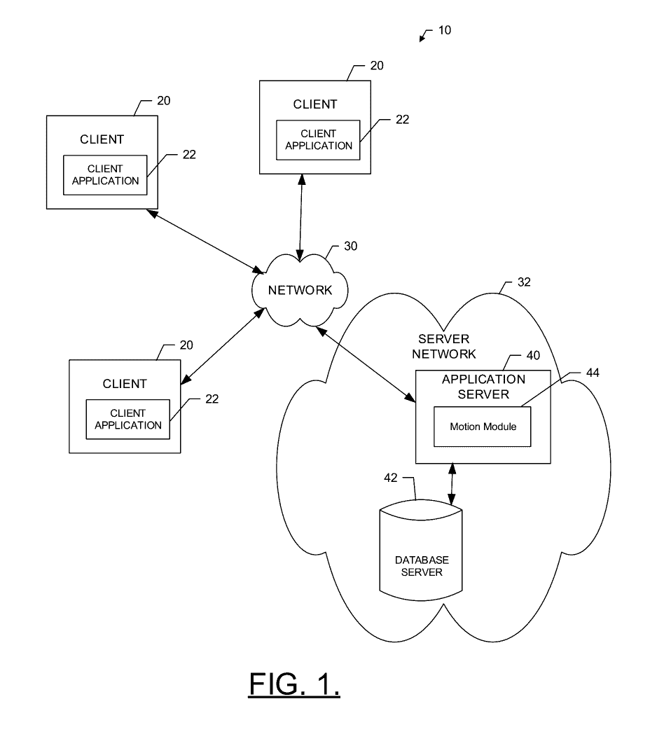

An example embodiment will now be described in reference to FIG. 1, which illustrates an example system in which an example embodiment may be employed. Although, the example embodiment discussed below is generally directed toward a security device, one of ordinary skill in the art would immediately appreciate that motion vector threshold determination may be beneficial to any electronic device, e.g., cellular phones laptop computers, or the like which are capable of intelligent transitions between active states, such as for extension of battery life. Additionally, although the motion vector threshold determination is described as being performed at the security device, in some embodiments, at least a portion of the vector determination may be performed at a server, such as a location tracking server or device, as discussed below. As shown in FIG. 1, a system 10 according to an example embodiment may include one or more client devices (e.g., clients 20). Notably, although FIG. 1 illustrates three clients 20, it should be appreciated that a single client or many more clients 20 may be included in some embodiments and thus, the three clients 20 of FIG. 1 are simply used to illustrate a potential for a multiplicity of clients 20 and the number of clients 20 is in no way limiting to other example embodiments. In this regard, example embodiments are scalable to inclusion of any number of clients 20 being tied into the system 10. Furthermore, in some cases, some embodiments may be practiced on a single client without any connection to the system 10.

The example described herein will be related to a client 20 comprising a security device or mobile computing device in one example embodiment. However, it should be appreciated that example embodiments may also apply to any asset including, for example, any programmable device that is capable of determining a motion vector, as described herein.

The clients 20 may, in some cases, each be associated with a single organization, department within an organization, or location (i.e. with each one of the clients 20 being associated with a building, store, department or location). However, in some embodiments, each of the clients 20 may be associated with different corresponding locations, departments or organizations. For example, among the clients 20, one client may be associated with a first facility of a first organization and one or more of the other clients may be associated with a second facility of either the first organization or of another organization.

Each one of the clients 20 may include or otherwise be embodied as security device or mobile computing device (e.g., a tablet computer, laptop computer, a network access terminal, a personal digital assistant (PDA), cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients 20 as described below. In an example embodiment, one or more of the clients 20 may include a client application 22 configured to operate in accordance with an example embodiment of the present invention. In this regard, for example, the client application 22 may include software for enabling a respective one of the clients 20 to communicate with the network 30 for requesting and/or receiving information and/or services via the network 30. Moreover, in some embodiments, the information or services that are requested via the network may be provided in a software as a service (SAS) environment. The information or services receivable at the client applications 22 may include deliverable components (e.g., downloadable software to configure the clients 20, or information for consumption/processing at the clients 20). As such, for example, the client application 22 may include corresponding executable instructions for configuring the client 20 to provide corresponding functionalities for motion vector threshold determination, as described in greater detail below.

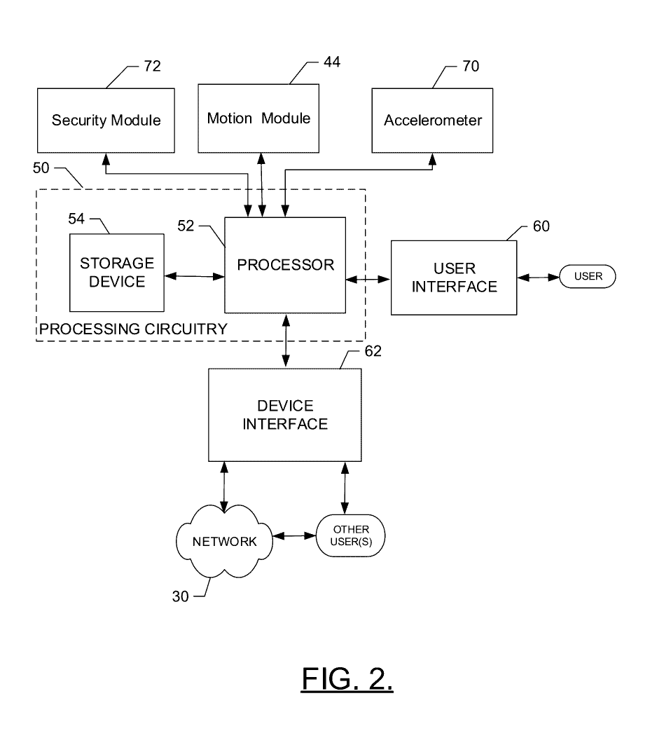

Each of the clients 20 may also include an accelerometer configured to measure the force of acceleration of movement and/or gravity, as discussed below in FIG. 2. Additionally, each of the clients 20 may include a security module configured to limit or prevent theft of an object to which the client is attached, as discussed below in FIG. 2.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) and/or databases. Communication between the network 30, the clients 20 and the devices or databases (e.g., servers) to which the clients 20 are coupled may be accomplished by either wireline or wireless communication mechanisms and corresponding communication protocols.

In an example embodiment, devices to which the clients 20 may be coupled via the network 30 may include one or more application servers (e.g., application server 40), and/or a database server 42, which together may form respective elements of a server network 32. Although the application server 40 and the database server 42 are each referred to as “servers,” this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the provision of access to information and/or services related to operation of the clients 20. For example, the application server 40 may be configured to provide for storage of information descriptive of motion or location). In some cases, these contents may be stored in the database server 42. Alternatively or additionally, the application server 40 may be configured to provide analytical tools for use by the clients 20 in accordance with example embodiments.

In some embodiments, for example, the application server 40 may therefore include an instance of a motion module 44 comprising stored instructions for handling activities associated with practicing example embodiments as described herein. As such, in some embodiments, the clients 20 may access the motion module 44 online and utilize the services provided thereby. However, it should be appreciated that in other embodiments, the motion module 44 may be initiated from an integrated memory of the client 20. In some example embodiments, the motion module 44 may be provided from the application server 40 (e.g., via download over the network 30) to one or more of the clients 20 to enable recipient clients to instantiate an instance of the motion module 44 for local operation. As yet another example, the motion module 44 may be instantiated at one or more of the clients 20 responsive to downloading instructions from a removable or transferable memory device carrying instructions for instantiating the motion module 44 at the corresponding one or more of the clients 20. In such an example, the network 30 may, for example, be a peer-to-peer (P2P) network where one of the clients 20 includes an instance of the motion module 44 to enable the corresponding one of the clients 20 to act as a server to other clients 20. In a further example embodiment, the motion module 44 may be distributed amongst one or more clients 20 and/or the application server 40.

In an example embodiment, the application server 40 may include or have access to memory (e.g., internal memory or the database server 42) for storing instructions or applications for the performance of various functions and a corresponding processor for executing stored instructions or applications. For example, the memory may store an instance of the motion module 44 configured to operate in accordance with an example embodiment of the present invention. In this regard, for example, the motion module 44 may include software for enabling the application server 40 to communicate with the network 30 and/or the clients 20 for the provision and/or receipt of information associated with performing activities as described herein. Moreover, in some embodiments, the application server 40 may include or otherwise be in communication with an access terminal (e.g., a computer including a user interface) via which analysts may interact with, configure or otherwise maintain the system 10.

An example embodiment will now be described with reference to FIG. 2. FIG. 2 shows certain elements of an apparatus for motion vector threshold determination according to an example embodiment. The apparatus of FIG. 2 may be employed, for example, on a client (e.g., any of the clients 20 of FIG. 1) or a variety of other devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40 or one or more clients 20) or by devices in a client/server relationship (e.g., the application server 40 and one or more clients 20). Furthermore, it should be noted that the devices or elements described below may not be mandatory and thus some may be omitted in certain embodiments.

Referring now to FIG. 2, an apparatus configured for motion vector threshold determination is provided. The apparatus may be an embodiment of the motion module 44 or a device hosting the motion module 44. As such, configuration of the apparatus as described herein may transform the apparatus into the motion module 44. In an example embodiment, the apparatus may include or otherwise be in communication with processing circuitry 50 that is configured to perform data processing, application execution and other processing and management services according to an example embodiment. In one embodiment, the processing circuitry 50 may include a storage device 54 and a processor 52 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various security devices. In situations where the processing circuitry 50 is embodied as a server or at a remotely located computing device, the user interface 60 may be disposed at another device (e.g., at a computer terminal or client device such as one of the clients 20) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms. In embodiments where the apparatus is embodied at a server or other network entity, the user interface 60 may be limited or even eliminated in some cases. Alternatively, as indicated above, the user interface 60 may be remotely located.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 54 may include one or more non-transitory storage or memory devices such as, for example, volatile and/or non-volatile memory that may be either fixed or removable. The storage device 54 may be configured to store information, data, applications, instructions or the like for enabling the apparatus to carry out various functions in accordance with example embodiments. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., client application 22 or database server 42) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an example embodiment, the processor 52 (or the processing circuitry 50) may be embodied as, include or otherwise control the motion module 44, which may be any means, such as, a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the motion module 44 as described below.

The motion module 44 may include tools to facilitate a motion vector threshold determination via the client 20, server network 32, network 30, or a combination thereof. In an example embodiment the motion module 44 may be configured for determining a gravity vector of a device, detecting a motion of the device, calculating a force vector of the motion, comparing the force vector to the gravity vector to determine a vector difference, and determining if the vector difference satisfies a predetermined difference threshold.

In some embodiments, the motion module 44 may further include one or more components or modules that may be individually configured to perform one or more of the individual tasks or functions generally attributable to the motion module 44. However, the motion module 44 need not necessarily be modular. In cases where the motion module 44 employs modules, the modules may, for example, be configured for motion vector threshold determination, as described herein. In some embodiments, the motion module 44 and/or any modules comprising the motion module 44 may be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the motion module 44 and/or any modules thereof, as described herein.

In some example embodiments, the apparatus may include an accelerometer 70. The accelerometer 70 may be configured to measure the force of acceleration, e.g., change in velocity, due to gravity and/or motion. The accelerometer 70 may also measure the angle or direction associated with the measured acceleration, e.g., determine a force or acceleration vector. The accelerometer 70 may provide the acceleration measurements to the processing circuitry 50 for various functions including a motion vector threshold determination, as discussed herein.

In an example embodiment, the apparatus may include a security module 72. The security module 72 may include or be associated with instructions and/or components for security functions. In an example embodiment, the security module 72 may cause an audible alarm to be activated in an instance in which a security breach is detected. Additionally or alternatively, the security module 72 may transmit a location beacon or signal for location tracking in an instance in which the apparatus detects a security breach or movement. In some example embodiments, a security breach may be detected if a lanyard securing the device to a product is cut, or damaged. In an example embodiment, a security breach may be determined in an instance in which the device passes through a specified electromagnetic or radio frequency field; or if the device is determined to be in motion.

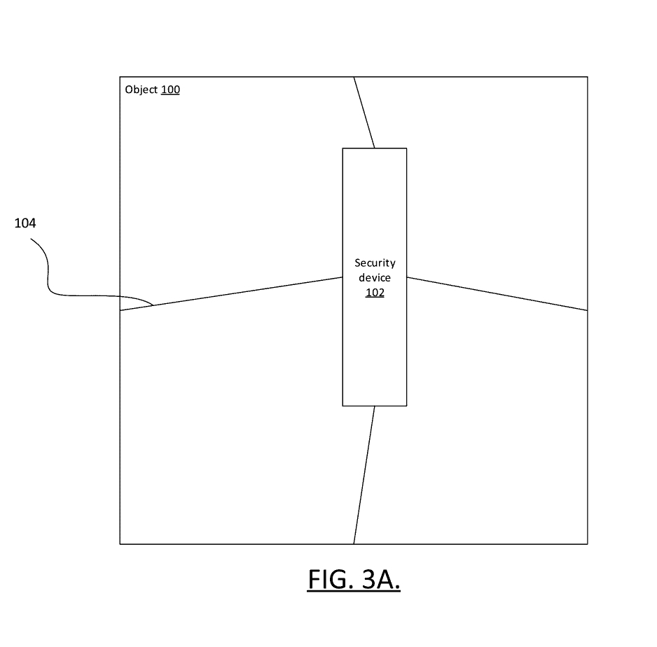

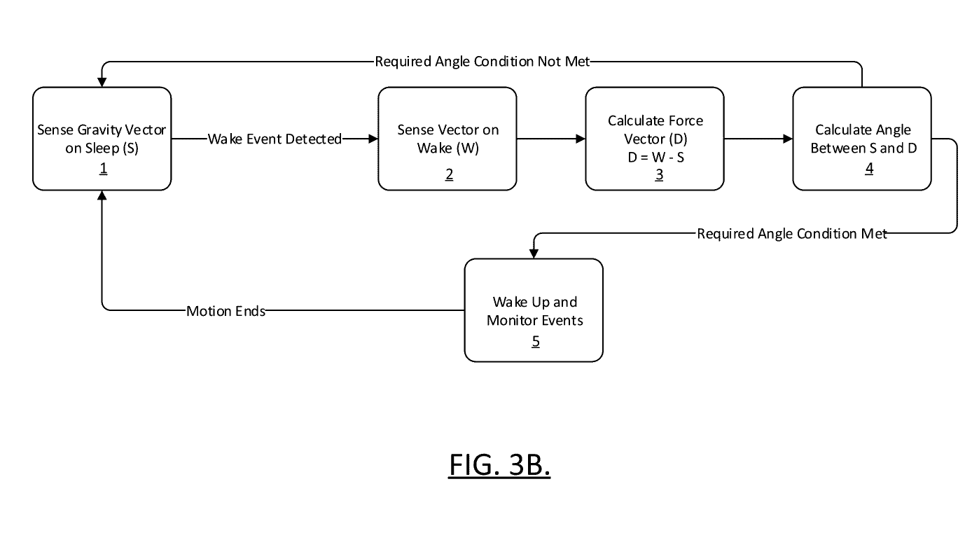

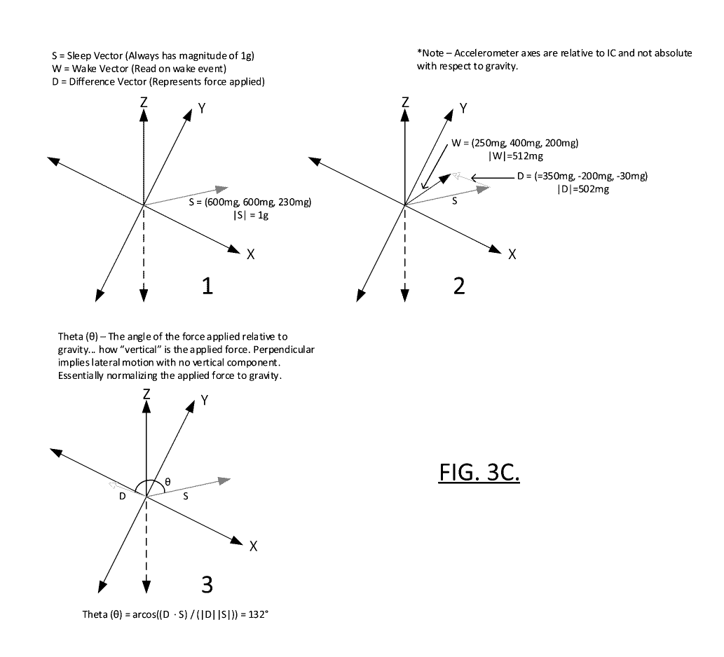

FIG. 3A illustrates a security device according to an example embodiment. A security device 102, such as a client 20 of FIG. 1, may be attached to an object 100, such as a product or package. The security device 102 may be attached to the object 100 by a lanyard 104, such as a tamper resistant cable. In some example embodiments, the security device 102 may be glued, or molded into the object 100. In some example embodiments the security device 102 may be within a product packaging. In an example embodiment, the security device 102 may be a portion of the object 100, such as a mobile device, e.g., phone, personal data assistance, portable computer, or the like, for example the mobile device may contain an accelerometer 70, processing circuitry 50, or the like, such as described in FIG. 2.

The security device 102 may be configured, by configuration of the processing circuitry, to perform security functions when in an active state. The security device 102 may also be configured to transition to an inactive state, to conserve energy and reduce location tracking load, in an instance in which the security device 102 determines that the security device 102 is stationary. To prevent spurious transitions to the active state, the security device 102 may be configured to perform a motion vector threshold determination as discussed below in reference to the descriptions of FIGS. 3B and 3C.

FIG. 3B illustrates a motion vector threshold determination loop in accordance with an example embodiment. A security device, such as security device 102 of FIG. 3, may perform the motion vector threshold determination. The motion vector threshold determination loop may start at block 1, sense a gravity vector on sleep (S). The security device 102 may include an accelerometer, such as accelerometer 70 of FIG. 2. The accelerometer 70 may sense a magnitude and direction of force, e.g., a vector. In an instance in which the accelerometer 70 senses a total magnitude of 1 g, indicative of the force of gravity and no other forces, e.g., the security device 102 is stationary. The security device 102 may determine a gravity vector (S) for the security device 102. The gravity vector (S) may be the force vector sensed by the accelerometer 70 when the security device 102 is stationary, e.g., 1 g total magnitude. The security device 102 may store the gravity vector (S) to a memory, such as the storage device 54.

The security device 102 may transition to an inactive state, e.g., a sleep state. In the inactive state the security device 102 may perform only minimal functions, such as, monitor the accelerometer 70, monitor a timer interrupt that triggers a status interaction with system in the event that no motion has been detected for a given period of time, or the like. In some embodiments, the security device 102 in the inactive state may perform some security functions, such as verifying security lanyard integrity, but not perform other security functions, such as transmitting a beacon signal or location data, detecting electromagnetic fields or radio frequencies, or the like.

In an instance in which the accelerometer 70 detects motion of the security device 102, e.g., a total force magnitude above a predetermined analyze threshold, such as 1.01 g, 1.1 g, or the like, the security device 102 may transition to an analyze state. The analyze state may include the functions described in blocks 2-4. The detection of motion of the security device 102 may be an example of a wake event that can be detected by the motion module 44 of FIGS. 1 and 2.

In an instance in which the security device 102 transitions to the analyze state responsive to detection of the wake event, the motion vector threshold determination loop may proceed to block 2, sense vector on wake, e.g., transition to analyze state.

The security device 102 may sense the total force and direction of acceleration of the security device 102. The security device 102 may detect or measure a sense vector (W), e.g., total force and direction of acceleration at or near the transition to the analyze state. In some instances, the accelerometer 70 may measure and report a snap shot of the total force and direction of acceleration which caused the security device 102 to transition to the analyze state. In an example embodiment, the security device 102 may store the sense vector to the memory.

The security device 102 may continue to block 3, calculate force vector (D). The force vector (D) may be calculated by subtracting the gravity vector (S) from the sense vector (W). In an example embodiment, the gravity vector (S) and/or the sense vector (W) may be received from the memory for the calculation of the force vector (D).

The security device 102 may continue to block 4, calculate the angle between the gravity vector (S) and the force vector (D). The security device 102 may compare the gravity vector (S) to the force vector (D) by calculating the angle between the gravity vector and the force vector to determine a vector difference. The security device 102 may compare the vector difference to a predetermined difference threshold. The predetermined difference threshold may be 180 degrees with a +/−1, 5, 10 degree or the like, margin indicative of vertical motion of the security device 102. Vertical motion detection may be beneficial in an instance in which the security device 102 may be attached to the object 100 on a pullout rack, since the security device 102 may not transition to an active state based on the horizontal motion of the rack, but may transition to the active state based on the vertical motion of lifting the object 100 off of the rack. In another embodiment, the predetermined difference threshold may be 90 degrees with a +/−1, 5, 10 degree, or the like, margin indicative of horizontal motion of the security device 102. Horizontal motion detection may be beneficial in an instance in which a product is on a drop or rising display, since the security device 102 may not transition to the active state based on the vertical motion, but may transition to the active state based on the horizontal motion indicative or removal of the product from the display.

In an example embodiment, the predetermined difference threshold may be a vector profile, including one or more specified three dimensional vectors. The force vector may include one or more force vectors which may be compared to the gravity vector, as discussed above to determine a device vector profile. The device vector profile may satisfy the vector profile threshold, in an instance in which the vector differences of the device vector profile are within a predetermine margin, such as 2 degrees, of the vector profile threshold. The vector profile threshold may be beneficial in an instance in which removal of the product may have a specific path or multiple turns.

In an instance in which the security device 102 determines that the vector difference satisfies the predetermined difference threshold, e.g., within the margin, the security device 102 may continue to block 5, wake up and monitor events. In an instance in which the vector difference fails to satisfy the predetermined difference threshold, e.g., outside of the margin, the security device 102 may not transition to an active state and return to block 1. In this regard, according to some example embodiments, the processing circuitry of the security device 102 may detect movement of the security device 102 via an accelerometer. However, since the determined movement vector does not satisfy the difference threshold criteria, the processing circuitry of the security device 102 does not transition into an active state, but rather remains in an inactive state.

In an instance in which the security device 102 returns to block 1, the security device 102 may transition to the inactive state. In an example embodiment, the security device 102 may reperform the gravity vector (S) determination and store the new gravity vector to memory. In some example embodiments, the security device 102 may use the previously stored gravity vector (S) for further motion vector determinations.

In an instance in which the security device 102 proceeds to block 5, the security device 102 may transition to an active state. In the active state, the security device 102 may utilize full functionality, such as performing all security functions. In some example embodiments, the security device 102 may report the gravity vector, force vector, vector difference, or the like to the location tracking device or other analytic device for security analytics or time stamping surveillance footage. The security device 102 may continue to monitor the motion of the device while in the active state.

The security device 102 may detect a cessation of motion. The accelerometer 70 of the security device 102 may detect a force vector having a total magnitude of 1 g indicating a cessation of motion. The security device 102 may compare a time during which no motion is sensed to a predetermined time threshold, such as 1-2 seconds. In an instance in which the security device 102 satisfies the predetermined time threshold, e.g., no motion (1 g), for greater than the time threshold, the security device 102 may return to block 1. In an instance in which the time threshold is not satisfied, the security device 102 continues in the active state.

In an instance in which the security device 102 returns to block 1, the security device 102 may transition to the inactive state. In an example embodiment, the security device 102 may reperform the gravity vector (S) determination and store the new gravity vector to memory prior to transitioning to the inactive state. In some example embodiments, the security device 102 may use the previously stored gravity vector (S) for further analysis.

FIG. 3C illustrates a difference vector determination according to an example embodiment. A series of three dimensional coordinate systems, e.g., system, are depicted each including x,y,z coordinates relative to the security device 102, which may not be absolute with respect to gravity. Systems 1, 2, and 3 depict the vectors and calculations of the an example motion vector threshold determination. In system 1, a sleep vector is depicted. The sleep vector may be the gravity vector (S) determined at the time of transition to the inactive state, as discussed in FIG. 3B. The sleep vector of the depicted example is equal to (600 mg, 600 mg, 230 mg) |S|=1 g, e.g., force of gravity with no motion. Accordingly, the sleep vector in FIG. 3C is labeled (S) since it corresponds to the gravity vector (S) in this example.

In system 2 a wake vector is detected or measured. The wake vector may be the sense vector (W) determined at the time the security device transitions to an analyze state, as discussed above in FIG. 3B. The wake vector is (250 mg, 400 mg, 200 mg) |W|=520 mg. Accordingly, the wake vector in FIG. 3C is labeled (W) since it corresponds to the sense vector (S) in this example.

The security system may determine a difference vector . The difference vector may be the force vector (D) representing the force applied to the security device 102 equal to the difference between the sleep vector (S) and the wake vector (W). In the depicted example, the difference vector is equal to (350 mg, −200 mg, −30 mg) |D|=502 mg. Accordingly, the difference vector in FIG. 3C is labeled (D) since it corresponds to the force vector (D) in this example.

In System 3 a vector difference is determined, e.g., the difference vector (D) compared to the sleep vector (S). The vector difference may be the angle of the difference between the difference vector (D) and the sleep vector (S) is represented by theta (θ). Theta (θ) may indicate the directionality of the motion. In the depicted example, theta (θ) is substantially perpendicular to the sleep vector (S), indicating lateral, e.g., horizontal motion of the security device 102, normalized for gravity. In the depicted example, theta (θ)=arcos((D*S)/(|D|*|S|))=132 degrees.

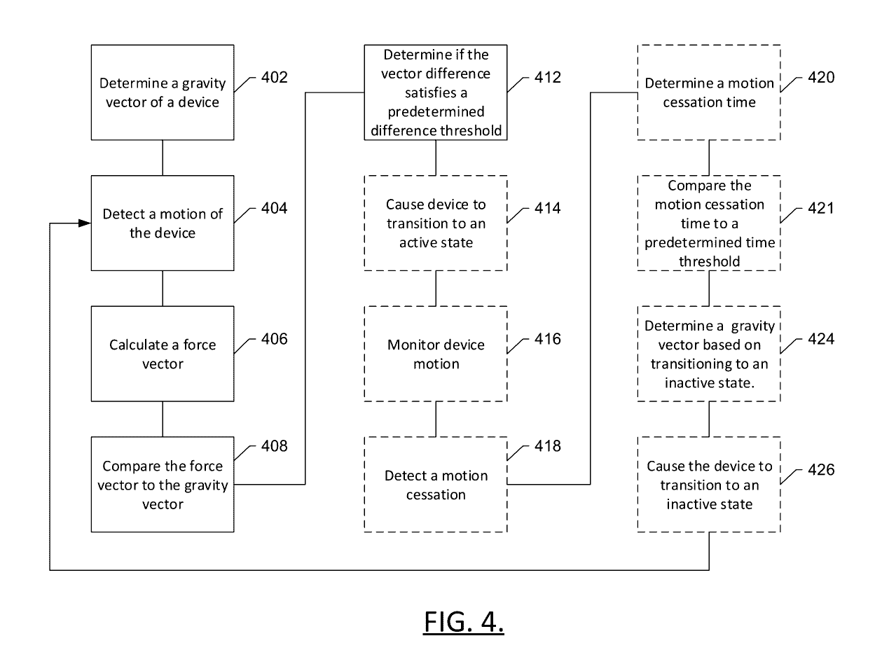

From a technical perspective, the motion module 44 described above may be used to support some or all of the operations described above. As such, the platform described in FIG. 2 may be used to facilitate the implementation of several computer program and/or network communication based interactions. As an example, FIG. 4 is a flowchart of a method and program product according to an example embodiment. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (e.g., client 20, application server 40, and/or the like) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one example embodiment is shown in FIG. 4. The method may be employed for a multi-step selection interface. The method may include, determining a gravity vector of a device, at operation 402. The method may also include detecting a motion of the device, at operation 404. At operation 406, the method may include calculating a force vector. The method, at operation 408, may include comparing the force vector to the gravity vector. At operation 412, the method may include determining if the vector difference satisfies a predetermined difference threshold.

In an example embodiment, the method may optionally include, as denoted by the dashed box, operation 414 causing the device to transition to an active state. The method may also optionally include monitoring the motion of the device, at operation 416, and detecting a motion cessation, at operation 418. In an example embodiment, the method may include determining a time during which no motion is sensed (e.g., a duration of motion cessation), at operation 420, and comparing the duration of motion cessation to a predetermined time threshold, at operation 421. In some example embodiments, the method may also include determining a gravity vector based on transitioning to an inactive state, at operation 424, and causing the device to transition to the inactive state, at operation 426.

In an example embodiment, an apparatus for performing the method of FIG. 4 above may comprise a processor (e.g., the processor 52) or processing circuitry configured to perform some or each of the operations (402-426) described above. The processor may, for example, be configured to perform the operations (402-426) by performing hardware implemented logical functions, executing stored instructions, or executing algorithms for performing each of the operations. In some embodiments, the processor or processing circuitry may be further configured for additional operations or optional modifications to operations 402-426. In this regard, for example, satisfaction of the predetermined difference threshold is indicative of the motion being in a vertical direction. In an example embodiment, the processing circuitry is further configured for causing the user device to transition to an active state in response to satisfaction of the predetermined difference threshold. In some example embodiments, the processing circuitry is further configured for monitoring user device motion in response to satisfaction of the predetermined difference threshold. In an example embodiment, the processing circuitry is further configured for detecting a motion cessation. In an example embodiment, the processing circuitry is further configured for determining a duration of motion cessation. In some example embodiments, the processing circuitry is further configured for comparing the duration of motion cessation to a predetermined time threshold. In an example embodiment, the determining a gravity vector comprises determining the gravity vector based on transitioning to an inactive state. In some example embodiments, the processing circuitry is configured for causing the device to transition to an inactive state responsive to satisfying a predetermined time threshold. In an example embodiment, the gravity vector is based on the orientation of the apparatus determined based on transitioning the device to an inactive mode.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An apparatus comprising processing circuitry configured to:
determine a gravity vector of a device;
detect a motion of the device;
calculate a force vector of the motion;
compare the force vector to the gravity vector to determine a vector difference; and
determine if the vector difference satisfies a predetermined difference threshold.

2. The apparatus of claim 1, wherein satisfaction of the predetermined difference threshold is indicative of at least a component of the motion being in a vertical direction.

3. The apparatus of claim 1, wherein the processing circuitry is further configured to:
cause the device to transition to an active state in response to satisfaction of the predetermined difference threshold.

4. The apparatus of claim 1, wherein the device does not transition to an active state in an instance in which the vector difference fails to satisfy the predetermined difference threshold.

5. The apparatus of claim 1, wherein the processing circuitry is further configured to:
monitor device motion in response to satisfaction of the predetermined difference threshold.

6. The apparatus of claim 5, wherein the processing circuitry is further configured to:
detect a motion cessation.

7. The apparatus of claim 6, wherein the processing circuitry is further configured to:
determine a duration of motion cessation; and
compare the duration of motion cessation to a predetermined time threshold.

8. The apparatus of claim 5, wherein the processing circuitry is configured to:
cause the device to transition to an inactive state responsive to satisfying a predetermined time threshold.

9. The apparatus of claim 1, wherein determining a gravity vector comprises determining the gravity vector based on transitioning to an inactive state.

10. The apparatus of claim 1, wherein the gravity vector is based on the orientation of the device determined based on transitioning the user device to an inactive mode.

11. A method comprising:
determining a gravity vector of a device;
detecting a motion of the device;
calculating a force vector of the motion;
comparing the force vector to the gravity vector to determine a vector difference; and
determining, using processing circuitry, if the vector difference satisfies a predetermined difference threshold.

12. The method of claim 11, wherein satisfaction of the predetermined difference threshold is indicative of at least a component of the motion being in a vertical direction.

13. The method of claim 11 further comprising:
causing the device to transition to an active state in response to satisfaction of the predetermined difference threshold.

14. The method of claim 11, wherein the device does not transition to an active state in an instance in which the vector difference fails to satisfy the predetermined difference threshold

15. The method of claim 11 further comprising:
monitoring device motion in response to satisfaction of the predetermined difference threshold.

16. The method of claim 14 further comprising:
detecting a motion cessation.

17. The method of claim 15 further comprising:
determining a duration of motion cessation; and
comparing the duration of motion cessation to a predetermined time threshold.

18. The method of claim 15 further comprising:
causing the device to transition to an inactive state responsive to satisfying a predetermined time threshold.

19. The method of claim 11, wherein determining a gravity vector comprises:
determining the gravity vector based on transitioning to an inactive state.

20. The method of claim 11, wherein the gravity vector is based on the orientation of the device determined based on transitioning the device to an inactive mode.
